(19) United States
(12) Patent Application Publication
(10) Pub. No.: US 2026/0205954 A1
(43) Pub. Date: Jul. 16, 2026

(54) OPEN LOOP POWER CONTROL OF RANDOM ACCESS SIGNALING IN SUB-BAND FULL DUPLEX SYSTEMS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US)

(21) Appl. No.: 19/019,874

(22) Filed: Jan. 14, 2025

(51) Int. Cl. H04W 52/10; H04L 5/14; H04W 74/0833

(52) U.S. Cl. CPC H04W 52/10; H04L 5/14; H04W 74/0833

(57) ABSTRACT

Methods, systems, and devices for wireless communications are described. A user equipment (UE) may receive random access configuration information that indicates a set of target power parameters and a set of power offset parameters. The set of target power parameters may be associated with a first slot type or a second slot type, and the set of power offset parameters may be associated with the first slot type or the second slot type. The UE may transmit a random access message during a random access occasion of the first slot type according to a first target power parameter of the set of target power parameters and a power ramping parameter.

### FIELD OF TECHNOLOGY

The following relates to wireless communications, including open loop power control of random access signaling in sub-band full duplex systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving random access configuration information that indicates a set of multiple target power parameters and a set of multiple power offset parameters, where the set of multiple target power parameters are associated with one of a first slot type or a second slot type and the set of multiple power offset parameters are associated with one of the first slot type or the second slot type, transmitting a random access message during a random access occasion of the first slot type according to a first target power parameter of the set of multiple target power parameters and a power ramping parameter, and transmitting an uplink shared channel message using an uplink shared channel resource of the second slot type according to a second target power parameter of the set of multiple target power parameters and a power offset parameter of the set of multiple power offset parameters.

A UE for wireless communications is described. The UE may include one or more memories storing processor executable code, and one or more processors coupled with the one or more memories. The one or more processors may individually or collectively be operable to execute the code to cause the UE to receive random access configuration information that indicates a set of multiple target power parameters and a set of multiple power offset parameters, where the set of multiple target power parameters are associated with one of a first slot type or a second slot type and the set of multiple power offset parameters are associated with one of the first slot type or the second slot type, transmit a random access message during a random access occasion of the first slot type according to a first target power parameter of the set of multiple target power parameters and a power ramping parameter, and transmit an uplink shared channel message using an uplink shared channel resource of the second slot type according to a second target power parameter of the set of multiple target power parameters and a power offset parameter of the set of multiple power offset parameters.

Another UE for wireless communications is described. The UE may include means for receiving random access configuration information that indicates a set of multiple target power parameters and a set of multiple power offset parameters, where the set of multiple target power parameters are associated with one of a first slot type or a second slot type and the set of multiple power offset parameters are associated with one of the first slot type or the second slot type, means for transmitting a random access message during a random access occasion of the first slot type according to a first target power parameter of the set of multiple target power parameters and a power ramping parameter, and means for transmitting an uplink shared channel message using an uplink shared channel resource of the second slot type according to a second target power parameter of the set of multiple target power parameters and a power offset parameter of the set of multiple power offset parameters.

A non-transitory computer-readable medium storing code for wireless communications is described. The code may include instructions executable by one or more processors to receive random access configuration information that indicates a set of multiple target power parameters and a set of multiple power offset parameters, where the set of multiple target power parameters are associated with one of a first slot type or a second slot type and the set of multiple power offset parameters are associated with one of the first slot type or the second slot type, transmit a random access message during a random access occasion of the first slot type according to a first target power parameter of the set of multiple target power parameters and a power ramping parameter, and transmit an uplink shared channel message using an uplink shared channel resource of the second slot type according to a second target power parameter of the set of multiple target power parameters and a power offset parameter of the set of multiple power offset parameters.

In some examples of the method, UEs, and non-transitory computer-readable medium described herein, transmitting the uplink shared channel message may include operations, features, means, or instructions for transmitting the uplink shared channel message using the uplink shared channel resource according to the second target power parameter that may be associated with the second slot type and the power offset parameter that may be associated with the first slot type.

In some examples of the method, UEs, and non-transitory computer-readable medium described herein, transmitting the uplink shared channel message may include operations, features, means, or instructions for transmitting the uplink shared channel message using the uplink shared channel resource according to the second target power parameter that may be associated with the first slot type and the power offset parameter that may be associated with the second slot type.

In some examples of the method, UEs, and non-transitory computer-readable medium described herein, transmitting the uplink shared channel message may include operations, features, means, or instructions for transmitting the uplink shared channel message using the uplink shared channel resource according to the second target power parameter that may be associated with the second slot type and the power offset parameter that may be associated with the second slot type, where the first slot type and the second slot type may be a same slot type.

In some examples of the method, UEs, and non-transitory computer-readable medium described herein, transmitting the random access message may include operations, features, means, or instructions for transmitting a set of multiple random access messages during a respective set of multiple random access occasions based on the power ramping parameter, the set of multiple random access messages including the random access message and the respective set of multiple random access occasions including the random access occasion, where at least one of the second target power parameter or the power offset parameter may be based on a slot type associated with a first random access occasion of the respective set of multiple random access occasions or a last random access occasion of the respective set of multiple random access occasions.

Some examples of the method, UEs, and non-transitory computer-readable medium described herein may further include operations, features, means, or instructions for selecting at least one of the second target power parameter from the set of multiple target power parameters and the power offset parameter from the set of multiple power offset parameters based on the uplink shared channel resource being of the second slot type.

Some examples of the method, UEs, and non-transitory computer-readable medium described herein may further include operations, features, means, or instructions for selecting at least one of the second target power parameter from the set of multiple target power parameters and the power offset parameter from the set of multiple power offset parameters based on a reference signal received power measurement or a path loss value satisfying a threshold.

Some examples of the method, UEs, and non-transitory computer-readable medium described herein may further include operations, features, means, or instructions for determining the power offset parameter based on a first power offset parameter that may be associated with the first slot type and a difference between the first target power parameter that may be associated with the first slot type and the second target power parameter that may be associated with the second slot type.

In some examples of the method, UEs, and non-transitory computer-readable medium described herein, the power offset parameter is associated with switching from transmission of the random access message using time division duplex resources to transmission of the uplink shared channel message using sub-band full duplex resources, switching from transmission of the random access message using the sub-band full duplex resources to transmission of the uplink shared channel message using the time division duplex resources, or transmission of both the random access message and the uplink shared channel message using the sub-band full duplex resources.

Some examples of the method, UEs, and non-transitory computer-readable medium described herein may further include operations, features, means, or instructions for transmitting capability information that indicates a set of multiple values for the set of multiple power offset parameters including at least a first power offset associated with the first slot type and a second power offset associated with the second slot type.

In some examples of the method, UEs, and non-transitory computer-readable medium described herein, the first slot type may be a sub-band full duplex slot and the second slot type may be a time division duplex slot, or the first slot type may be a time division duplex slot and the second slot type may be a sub-band full duplex slot.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports open loop power control of random access signaling in sub-band full duplex systems in accordance with one or more aspects of the present disclosure.

FIG. 2 shows an example of a wireless communications system that supports open loop power control of random access signaling in sub-band full duplex systems in accordance with one or more aspects of the present disclosure.

FIG. 3 shows examples of power ramping scenarios that support open loop power control of random access signaling in sub-band full duplex systems in accordance with one or more aspects of the present disclosure.

FIG. 4 shows an example of a process flow that supports open loop power control of random access signaling in sub-band full duplex systems in accordance with one or more aspects of the present disclosure.

FIGS. 5 and 6 show example block diagrams of devices that support open loop power control of random access signaling in sub-band full duplex systems in accordance with one or more aspects of the present disclosure.

FIG. 7 shows an example block diagram of a communications manager that supports open loop power control of random access signaling in sub-band full duplex systems in accordance with one or more aspects of the present disclosure.

FIG. 8 shows an example diagram of a system including a device that supports open loop power control of random access signaling in sub-band full duplex systems in accordance with one or more aspects of the present disclosure.

FIGS. 9 and 10 show example flowcharts illustrating methods that support open loop power control of random access signaling in sub-band full duplex systems in accordance with one or more aspects of the present disclosure.

### DETAILED DESCRIPTION

A wireless communications system may support sub-band full-duplex (SBFD) communications (e.g., communications where one or more carriers are each split into sub-bands to enable simultaneous transmission and reception in one or more same slots). A wireless device that supports SBFD communications, such as a user equipment (UE), may use uplink resources that are configured in a downlink slot to transmit uplink signaling. In some examples, a UE may use SBFD communications for random access signaling. For example, the UE may be configured with a first set of random access occasions that correspond to uplink symbols of uplink slots, and the UE may be configured with a second, or additional, set of random access occasions that correspond to SBFD symbols in downlink slots. In some examples, the random access occasions in uplink symbols may be referred to as TDD random access occasions, and the random access occasions in SBFD symbols may be referred to as SBFD random access occasions.

In some examples, a UE may perform open loop power control for random access signaling, such as for an uplink shared channel message that is transmitted during a random access procedure. For example, the UE may transmit a random access preamble using a nominal transmit power based on a target power (e.g., an initial Po) and a power ramping step, which is adjusted (e.g., incremented) based on a quantity of retransmissions the UE performs for the random access message. After transmitting the random access preamble, the UE may transmit an uplink shared channel message for the random access procedure. To transmit the uplink shared channel message, the UE may apply a power offset, or delta, to the transmit power used to transmit the random access preamble, which may assist the receiver, such as a network entity, in decoding the uplink shared channel message.

In some other wireless communications systems, a UE may be configured with power control parameters which the UE uses to communicate random access signaling according to either a first slot type or a second slot type. For example, the UE may transmit a random access preamble in a TDD random access occasion according to TDD power control parameters, and the UE may transmit an uplink shared channel message in a TDD uplink slot according to the TDD power control parameters.

However, a UE that supports SBFD communications may transmit a random access preamble and an uplink shared channel message via different types of slots. For example, the UE may transmit a random access preamble of a random access procedure via a TDD random access occasion and transmit an uplink shared channel message of the random access procedure via SBFD resources. Open loop power control techniques of other wireless communications systems may not provide for a UE to transmit a random access preamble and a uplink shared channel message of a random access procedure using different slot types.

Wireless communications systems described herein support open loop power control techniques for an uplink shared channel message, such as an uplink shared channel message transmitted for a random access procedure, while supporting SBFD communications. A UE may be configured with a first set of power control parameters for TDD slots and a second set of power control parameters for SBFD slots, or slots which include SBFD resources. For open loop power control of transmission of the uplink shared channel message of the random access procedure, the UE may use, for example, a target transmit power parameter of the first set of power control parameters (e.g., a TDD target power parameter) and a power offset parameter of the second set of power control parameters (e.g., an SBFD power offset parameter). In some examples, the UE may use a target transmit power parameter of the second set of power control parameters (e.g., an SBFD target power parameter) and a power offset parameter of the first set of power control parameters (e.g., a TDD power offset parameter). The first set of power control parameters associated with TDD slots may include a target transmit power parameter, a power offset parameter, and a power ramping parameter. The second set of power control parameters associated with SBFD slots may include one or more target transmit power parameters, one or more power offset parameters, and one or more power ramping parameters. For example, the second set of power control parameters may include a first power offset parameter that is used when switching from a TDD slot for transmission of the random access preamble to an SBFD slot for transmission of the uplink shared channel message, and the second set of power control parameters may include a second power offset parameter that is used when switching from an SBFD slot for transmission of the random access preamble to a TDD slot for transmission of the uplink shared channel message.

Additional techniques are described for open loop power control of an uplink shared channel message in an SBFD system. In some examples, the UE may determine a value for the power offset parameter associated with SBFD slots based on, for example, a difference between a target transmit power parameter for TDD slots and a target transmit power parameter for SBFD slots. In some examples, the UE may select power control parameters based on a slot type for a first or last retransmission of a random access preamble. In some examples, the UE may transmit capability information associated with open loop power control associated with SBFD communications.

Aspects of the disclosure are initially described in the context of wireless communications systems. Aspects of the disclosure are further illustrated by and described with reference to apparatus diagrams, system diagrams, and flowcharts that relate to open loop power control of random access signaling in sub-band full duplex systems.

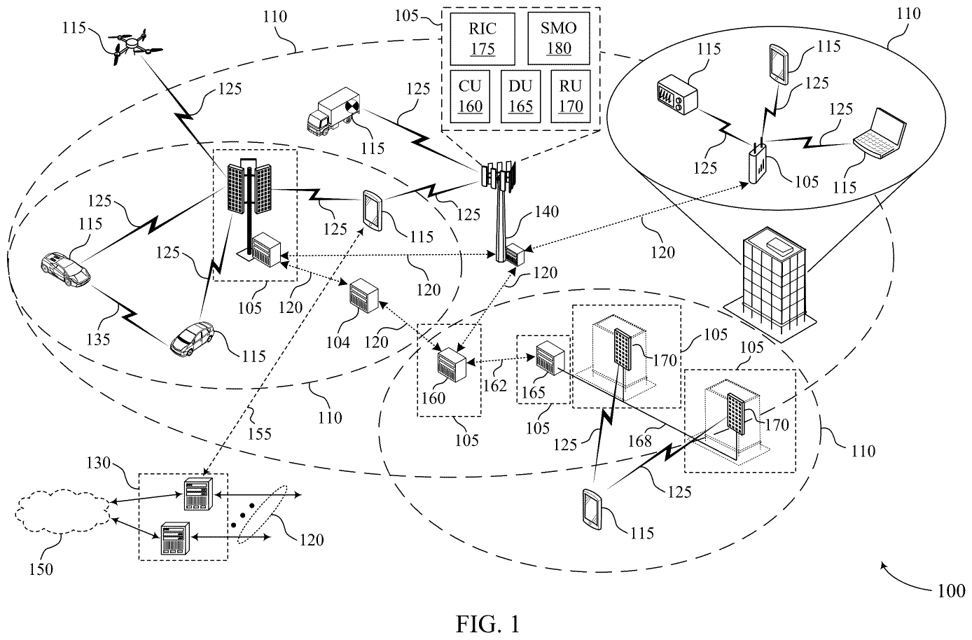

FIG. 1 shows an example of a wireless communications system 100 that supports open loop power control of random access signaling in sub-band full duplex systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support open loop power control of random access signaling in sub-band full duplex systems as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions.

Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may perform power control for random access signaling. For example, the UE 115 may receive a random access configuration indicating power control parameters for the random access signaling. In some examples, the random access configuration may include a target power for a random access preamble (e.g., PREAMBLE_RECEIVED_TARGET_POWER) and a power ramping parameter. The UE 115 may transmit the random access preamble using the configured target power and adjust the transmit power according to the power ramping parameter based on a quantity of retransmissions. In some examples, the target power for the random access preamble may be indicated by a common configuration for a physical random access channel configuration. For example, higher layer signaling, such as RRC signaling, may indicate the random access configuration, including the physical random access channel configuration and the target power for the random access preamble.

A UE 115 in the wireless communications system 100 may perform open loop power control for random access signaling, such as for an uplink shared channel message that is transmitted by the UE 115 during a random access procedure. If the UE 115 transmit a physical uplink shared channel (PUSCH) signal on an active uplink bandwidth part, b, of serving cell c using parameter set configuration with index j and PUSCH power control adjustment state j and PUSCH power control adjustment state with index l, the UE 115 may determine a PUSCH transmission power, P_{PUSCH,b,f,c}(i,j,q_{d}l) in PUSCH transmission occasion i based on a smaller value, or minimum, between a UE-configured maximum output power and another PUSCH transmit power based on P_{O_PUSCH,b,f,c}. The parameter P_{O_PUSCH,b,f,c} may correspond to a sum of a nominal transmit power, P_{O_NOMINAL_PUSCH,f,c}(j), and a parameter P_{O_UE_PUSCH,b,f,c}(j), where j may range from 0 to J−1. If the UE 115 establishes a dedicated RRC connection using a Type-1 random access procedure, or a four-step random access procedure, j may be set to 0, and the parameter P_{O_NOMINAL_PUSCH,f,c}(j) may be based on a sum of P_{O_PRE}+Δ_{PREAMBLE_Msg3}. P_{O_PRE} may correspond to a preamble received target power, or a transmit power used to transmit a random access preamble. In some examples, P_{O_PRE} may be set based on higher layer parameters and a quantity of retransmission attempts performed for the random access preamble. The parameter Δ_{PREAMBLE_Msg3} may correspond to a power offset that is applied for transmission of a third random access message (e.g., Message 3 or Msg3) of a Type-1 random access procedure. If the UE 115 established dedicated RRC connection using a Type-2 random access procedure (e.g., a four-step random access procedure), j may be set to 0, and P_{O_NOMINAL PUSCH,f,c}(j) may correspond to a sum of P_{O_PRE} and Δ_{MsgA_PUSCH}, where P_{O_PRE} corresponds to a Message A (MsgA) preamble received target power, or by the preamble received target power if MsgA preamble received target power is not provided, and Δ_{MsgA_PUSCH} corresponds to a power offset that is applied for transmission of the uplink shared channel portion of MsgA.

For example, the UE 115 may transmit a random access preamble using a target transmit power based on a target power and a power ramping step, which is incremented based on a quantity of retransmissions the UE performs for the random access message. The UE 115 may perform the random access preamble using a target transmit power, P₀, which may include power ramping steps from retransmissions of the random access preamble. The UE 115 may transmit an uplink shared channel message as part of the random access procedure using a nominal transmit power that is based on a sum of the target transmit power, P₀, and a power offset, or delta. For example, to transmit the uplink shared channel message, the UE may apply the power offset, or delta, to the transmit power used to transmit the random access preamble, P₀. Applying the power offset may assist the receiver, such as a network entity 105, in decoding the uplink shared channel message. The uplink shared channel message may be transmitted in response to a random access response message. For example, the random access response message may be a second random access message of a Type-1 random access procedure, and the uplink shared channel message may be a third random access message of a Type-1 random access procedure. In some other examples, the uplink shared channel message may be transmitted as part of Message A of a Type-2 random access procedure.

The wireless communications system 100 may support SBFD communications. A UE 115 which supports SBFD communications (e.g., an SBFD-aware UE 115), may use uplink resources that are configured in a downlink slot to transmit uplink signaling. For example, an uplink subband may be configured within a TDD downlink slot, and SBFD-aware UEs 115 may use the uplink resources of the uplink subband for uplink signaling during the TDD downlink slot. In some examples, a TDD downlink slot which includes an uplink subband which can be used by SBFD-aware devices may be referred to as an SBFD slot.

In some examples, a UE 115 may use SBFD communications for random access signaling or random access operation. For example, the UE 115 may be configured with a first set of random access occasions that correspond to uplink symbols of uplink slots, and the UE 115 may be configured with a second, or additional, set of random access occasions that correspond to SBFD symbols in downlink slots. The random access occasions in uplink symbols may be referred to as TDD random access occasions, and the random access occasions in SBFD symbols may be referred to as SBFD random access occasions.

In some examples, the UE 115 may use a single random access channel configuration for both TDD random access occasions and SBFD random access occasions. For example, random access occasions within an uplink subband in SBFD symbols may be valid for SBFD-aware UEs 115. In some other examples, the UE 115 may use separate random access configurations for the TDD random access occasions and the SBFD random access occasions, such as a first TDD random access configuration and a second SBFD random access configuration. The random access occasions within an uplink subband in SBFD symbols may be configured by the SBFD random access configuration and may be valid for SBFD-aware UEs 115.

For example, using a single random access configuration for both TDD random access occasions and SBFD random access occasions may correspond to using the same parameters of the random access configuration for both types of slots. For example, random access occasions in TDD uplink slots (e.g., TDD random access occasions) and random access occasions in an uplink subband of a downlink slot (e.g., SBFD random access occasions) may have a same physical random access channel (PRACH) configuration index, preamble format, slot formant number mode, subframe number, starting symbol, quantity for PRACH slots within a subframe, quantity of time domain PRACH occasions within PRACH slots, and PRACH duration. Using separate random access channel configurations for TDD random access occasions and SBFD random access occasions may enable the network to configure different values for one or more of these parameters. For example, a UE 115 may be configured to use a first PRACH configuration index when transmitting a random access preamble via a TDD random access occasion and a second PRACH configuration index when transmitting a random access preamble via an SBFD random access occasion, or the TDD random access occasions and SBFD random access occasions may be configured to be in different subframes (e.g., according to respective configurations indicating different subframe numbers).

The wireless communications system 100 may support open loop power control techniques which are implemented by an SBFD-aware UE to transmit an uplink shared channel message of a random access procedure. The UE 115 may be configured with multiple power control parameters. For example, the UE may be configured with a first set of power control parameters for TDD slots and a second set of power control parameters for SBFD slots, or slots which include SBFD resources. For open loop power control of transmission of the uplink shared channel message of the random access procedure, the UE may use, for example, a target transmit power parameter of the first set of power control parameters (e.g., a TDD target power parameter) and a power offset parameter of the second set of power control parameters (e.g., an SBFD power offset parameter). In another example, the UE may use a target transmit power parameter of the second set of power control parameters (e.g., an SBFD target power parameter) and a power offset parameter of the first set of power control parameters (e.g., a TDD power offset parameter).

The first set of power control parameters associated with TDD slots may include a target transmit power parameter, a power offset parameter, and a power ramping parameter. The second set of power control parameters associated with SBFD slots may include one or more target transmit power parameters, one or more power offset parameters, and one or more power ramping parameters. For example, the second set of power control parameters may include a first power offset parameter that is used when switching from a TDD slot for transmission of the random access preamble to an SBFD slot for transmission of the uplink shared channel message, and the second set of power control parameters may include a second power offset parameter that is used when switching from an SBFD slot for transmission of the random access preamble to a TDD slot for transmission of the uplink shared channel message.

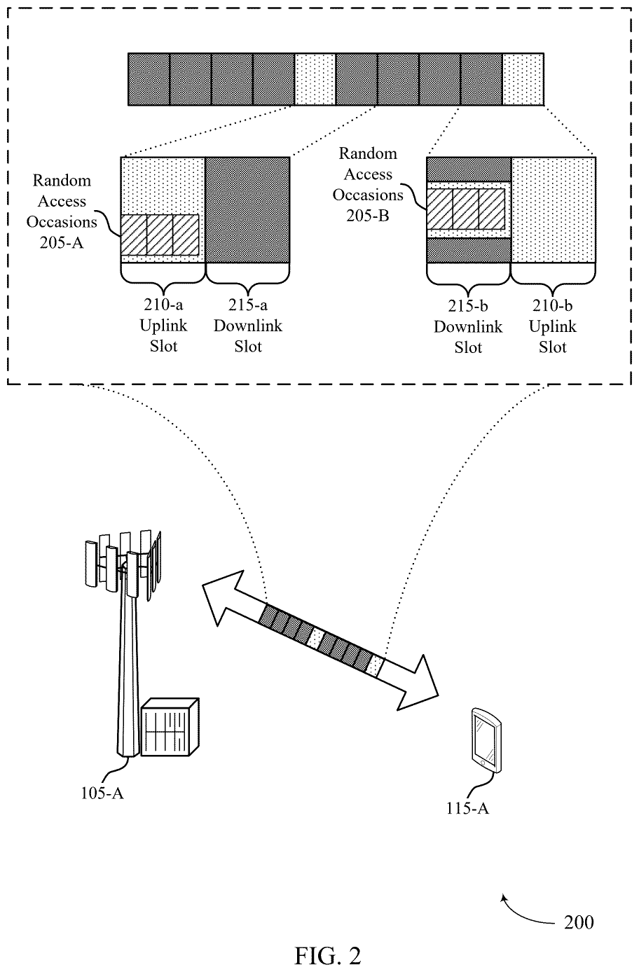

FIG. 2 shows an example of a wireless communications system 200 that supports open loop power control of random access signaling in sub-band full duplex systems in accordance with one or more aspects of the present disclosure. The wireless communications system 200 may implement aspects of a wireless communications system 100. For example, the wireless communications system 200 may include a UE 115-a and a network entity 105-a, which may be respective examples of a UE 115 and a network entity 105 described herein.

The UE 115-a may be capable of SBFD communications and may be an example of an SBFD-aware UE. For example, the UE 115-a may be configured with a first set of random access occasions 205-a and a second set of random access occasions 205-b. The first set of random access occasions 205-a may be configured on uplink resources in TDD uplink slots. The second set of random access occasions 205-b may be configured on an uplink subband of a TDD downlink slot. For example, the second set of random access occasions 205-b may be an example of an additional set of random access occasions which may be used by SBFD-aware devices, such as the UE 115-a. In some examples, the first set of random access occasions 205-a may be referred to as TDD random access occasions, or random access occasions on TDD resources, and the second set of random access occasions 205-b may be referred to as SBFD random access occasions, or random access occasions on SBFD resources.

The network entity 105-a may transmit control signaling to indicate configuration information to the UE 115-a. For example, the network entity 105-a may transmit random access configuration information to the UE 115-a. In some examples, the random access configuration information may include a first configuration for the first set of random access occasions 205-a and a second configuration for the second set of random access occasions 205-b. For example, the network entity 105-a may configure the UE 115-a with separate random access channel configurations for the first set of random access occasions 205-a and the second set of random access occasions 205-b. For example, the first set of random access occasions 205-a may be configured in subframe 2 (e.g., including an uplink slot 210-a and subframe 7 of a radio frame, while the second set of random access occasions 205-b may be configured in subframe 4 (e.g., including a downlink slot 215-b) and subframe 9 of the radio frame. A downlink slot 215-a in subframe 7 may not include the second set of random access occasions 205-b, and an uplink slot 210-b in subframe 9 may not include the first set of random access occasions 205-a. In some examples, the downlink slot 215-a may not include SBFD resources or be considered an SBFD slot, while the downlink slot 215-b may include SBFD resources and may be considered an SBFD slot.

In some other examples, the network entity 105-a may configure the UE 115-a with a single random access channel configuration for random access occasions on uplink symbols of an uplink slot 210 (e.g., the first set of random access occasions 205-a) and random access occasions on SBFD symbols of a downlink slot 215 (e.g., the second set of random access occasions 205-b).

In some examples, the configuration information may include power control parameters. For example, the network entity 105-a may indicate a first set of power control parameters associated with a first type of slot, such as a TDD slot, or a first type of resources, such as TDD resources. The first set of power control parameters may include, for example, a first target transmit power, or P_{0(TDD)}, and a first power offset, or msg3_{DeltaPreamble(TDD)}.

The configuration information may include one or more second sets of power control parameters associated with a second type of slot, such as an SBFD slot, or a second type of resources, such as SBFD resources. Each of the one or more second sets of power control parameters may each include, for example, a second target transmit power, or P_{0(SBFD)}, and a second power offset, or msg3_{DeltaPreamble(SBFD)}.

During a random access procedure, the UE 115-a may transmit a random access preamble and an uplink shared channel message. The uplink shared channel message may be an example of a third random access message, or Message 3, of a Type-1 random access procedure. In some other examples, the uplink shared channel message may be included as part of a Message A in a Type-2 random access procedure. The UE 115-a may perform open loop power control for the uplink shared channel message in accordance with the power control parameters included in the configuration information.

In some examples, a slot type for the random access preamble and the uplink shared channel message may be the same. For example, the UE 115-a may transmit the random access preamble via a TDD slot, and the UE 115-a may transmit the uplink shared channel message via a TDD slot. The UE 115-a may determine a nominal transmit power for the uplink shared channel message based on the first target transmit power and the first power offset.

In some other examples, the UE 115-a may transmit the random access preamble and the uplink shared channel message of a random access procedure on different slot types. For example, the UE 115-a may transmit the random access preamble via a random access occasion in a TDD slot, and the UE 115-a may transmit the uplink shared channel message via SBFD resources of an SBFD slot. In some other examples, the UE 115-a may transmit the random access preamble via a random access occasion in an SBFD slot, or in SBFD resources of a downlink slot, and the UE 115-a may transmit the uplink shared channel message via uplink resources in a TDD slot.

The UE 115-a may apply different open loop power control parameters for these different scenarios. In some examples, the UE 115-a may be configured to use certain parameters for the different scenarios. For example, the configuration information may indicate which parameters to use based on the slot type for the random access preamble and the slot type for the uplink shared channel message. Additionally, or alternatively, parameters included in, or indicated by, the configuration information may correspond to different slot types or slot type combinations of the random access preamble and the uplink shared channel message.

For example, the UE 115-a may transmit a random access preamble of a random access procedure in a TDD random access occasion (e.g., of the first set of random access occasions 205-a), and the UE 115-a may transmit an uplink shared channel message of the random access procedure via SBFD symbols. In some examples, the UE 115-a may be configured to use a TDD-specific target power, P_{0(TDD}), and an SBFD-specific power offset value, msg3_{DeltaPreamble(SBFD)}. In some other examples, the UE 115-a may be configured to use an SBFD-specific target power, P_{0(SBFD)}, and a TDD-specific power offset, msg3_{DeltaPreamble(TDD)}. In some examples, the UE 115-a may use an SBFD-specific target power value and an SBFD-specific power offset value. In some examples, the UE 115-a may be configured to use dedicated values (e.g., P₀ and msg3_{DeltaPreamble}) for a case where the random access preamble is transmitted in a half-duplex or TDD slot and the uplink shared channel message is transmitted in an SBFD slot. For example, the UE 115-a may be configured (e.g., via the configuration information) with a target power value, P₀, and a power offset value msg3_{DeltaPreamble(TDD→SBFD)}, which the UE 115-a is to use when the UE 115-a transmits a random access preamble via a random access occasion in a TDD slot and transmits an uplink shared channel message of the random access procedure in an SBFD slot.

In some examples, the UE 115-a may transmit a random access preamble of a random access procedure in a random access occasion in an SBFD slot (e.g., of the second set of random access occasions 205-b), and the UE 115-a may transmit an uplink shared channel message of the random access procedure via TDD symbols, or non-SBFD symbols. In some examples, the UE 115-a may be configured to use a TDD-specific target power, P_{0(TDD)}, and an SBFD-specific power offset value, msg3_{DeltaPreamble(SBFD)}. In some other examples, the UE 115-a may be configured to use an SBFD-specific target power, P_{0(SBFD)}, and a TDD-specific power offset, msg3_{DeltaPreamble(TDD)}. In some examples, the UE 115-a may be configured to use dedicated values (e.g., P₀ and msg3_{DeltaPreamble}) for a case where the random access preamble is transmitted in an SBFD random access occasion and the uplink shared channel message is transmitted in a half-duplex or TDD slot. For example, the UE 115-a may be configured (e.g., via the configuration information) with a target power value, P₀, and a power offset value msg3_{DeltaPreamble(SBFD→TDD)}, which the UE 115-a is to use when the UE 115-a transmits a random access preamble via a random access occasion in an SBFD slot and transmits an uplink shared channel message of the random access procedure in a TDD slot.

In some examples, the UE 115-a may transmit a random access preamble of a random access procedure in a random access occasion in an SBFD slot (e.g., of the second set of random access occasions 205-b), and the UE 115-a is schedule to transmit an uplink shared channel message of the random access procedure in an SBFD symbols. In some examples, the UE 115-a may use the first target power value and the first power offset value associated with TDD slots for open loop power control of the uplink shared channel message that is scheduled to be transmitted in the SBFD symbols. In some examples, the UE 115-a may be configured to use an SBFD target power value and an SBFD power offset value. In some examples, the UE 115-a may be configured to use dedicated values (e.g., P₀ and msg3_{DeltaPreamble}) for a case where the random access preamble is transmitted in an SBFD random access occasion and the uplink shared channel message is transmitted in SBFD symbols. For example, the UE 115-a may be configured (e.g., via the configuration information) with a target power value, P₀, and a power offset value msg3_{DeltaPreamble(SBFD→SBFD)}, which the UE 115-a is to use for open loop power control when the UE 115-a transmits a random access preamble via a random access occasion in an SBFD slot and transmits an uplink shared channel message of the random access procedure in an SBFD slot.

If the UE 115-a is configured with multiple values of a PRACH target power, P₀, configured for random access preamble transmission, the UE 115-a may select one of the PRACH target power values for open loop power control of an uplink shared channel message of the random access procedure. For example, the UE 115-a may be configured with a first PRACH target power configured for PRACH transmission in a random access occasion of the first set of random access occasions 205-a and a second PRACH target power configured for PRACH transmission in a random access occasion of the second set of random access occasions 205-b.

In some examples, the UE 115-a may not switch between random access occasion types when transmitting the random access preamble, and the UE 115-a may select the PRACH target power that corresponds to the random access occasion type of the PRACH transmission. For example, if the UE 115-a transmits the random access preamble using one of the first set of random access occasions 205-a, the UE 115-a may select P_{0(TDD)} for power control of the uplink shared channel message.

In some other examples, the UE 115-a may transmit a random access preamble, or retransmissions of the random access preamble, using multiple types of random access occasions. For example, if the UE 115-a may retransmit the random access preamble, or perform PRACH retransmission, and the UE 115-a switch from transmitting the random access preamble using the first set of random access occasions 205-a to the second set of random access occasions 205-b, or switch from transmitting the random access preamble using the second set of random access occasions 205-b to the first set of random access occasions 205-a. In some examples, the UE 115-a may select a target power parameter based on a random access occasion type of a last PRACH transmission. In some other examples, the UE 115-a may select a target power parameter based on a random access occasion type of a first PRACH transmission.

In some examples, the UE 115-a may select a target power parameter based on a slot type of the uplink shared channel message. For example, the UE 115-a may select the PRACH target power based on a slot type of the Message 3 PUSCH. If the Message 3 PUSCH is scheduled, such as by a grant included in a random access response, or rescheduled, such as by downlink control information scrambled with a random access radio network temporary identifier (RA-RNTI), in SBFD symbols, the UE 115-a may select a PRACH target power corresponding to the second set of random access occasions 205-b, or P_{0(SBFD)}. If the Message 3 PUSCH is scheduled or rescheduled in non-SBFD symbols, the UE 115-a may select a PRACH target power of the first set of random access occasions 205-a, or P_{0(TDD)}. In some examples, the UE 115-a may select the target power parameter based on reference signal received power (RSRP) measurements or path loss measurements, or both. For example, the UE 115-a may select the target power based on whether the RSRP measurement or a path loss value, or both, satisfy respective thresholds.

If the UE 115-a is configured with multiple values for a power offset (e.g., msg3_{DeltaPreamble}), the UE 115-a select a power offset from the multiple values for open loop power control of an uplink shared channel message of a random access procedure. For example, if the UE 115-a is configured with an msg3_{DeltaPreamble(SBFD)} and an msg3_{DeltaPreamble(TDD)}, the UE 115-a may select one for open loop power control of uplink shared channel message. In some examples, the UE 115-a may select the power offset based on a slot type of the uplink shared channel message. For example, if a Message 3 PUSCH is scheduled or rescheduled in SBFD symbols, the UE 115-a may select msg3_{DeltaPreamble(SBFD)}. If the Message 3 PUSCH is scheduled or rescheduled in non-SBFD symbols, the UE 115-a may select msg3_{DeltaPreamble(TDD)}.

In some examples, the UE 115-a may select the power offset value based on a random access occasion type of the random access preamble. For example, the UE 115-a may select msg3_{DeltaPreamble(TDD)} if the UE 115-a transmitted the random access preamble in non-SBFD symbols. In some examples, the UE 115-a may select the power offset value based on the random access occasion type of the random access preamble if the UE 115-a does not perform PRACH retransmission. If the UE 115-a does perform PRACH retransmission, the UE 115-a may select the power offset value based on a random access occasion type of the first PRACH transmission or a random access occasion type of the last PRACH transmission. In some examples, the UE 115-a may select the power offset value based on a measured RSRP or path loss value. For example, the UE 115-a may select the power offset based on whether an RSRP measurement satisfies a threshold or a path loss value satisfies a threshold, or both.

In some examples, a power offset value associated with SBFD slots may be based on a power offset value associated with TDD slots. For example, Msg3_{DeltaPreamble(SBFD)} may be based on Msg3_{DeltaPreamble(TDD)}. In some examples, the UE 115-a or the network entity 105-a, or both, may derive a value for msg3_{DeltaPreamble(SBFD)}. For example, msg3_{DeltaPreamble(SBFD)} may be equal to msg3_{DeltaPreamble(TDD)}+(P₀(SBFD)−P₀(TDD)).

In some examples, the UE 115-a may be configured with multiple power offset values based on different slot types used for the random access preamble and the uplink shared channel message. For example, the UE 115-a may be configured with a first power offset, msg3_{DeltaPreamble (TDD)}. The first power offset may be used when both PRACH and Message 3 PUSCH transmission occur in non-SBFD symbols. The UE 115-a may be configured with a second power offset, msg3_{DeltaPreamble(TDD→SBFD)}. The second power offset may be used when PRACH transmission occurs in non-SBFD symbols, and Message 3 PUSCH transmission occurs in SBFD symbols. The UE 115-a may be configured with a third power offset, msg3_{DeltaPreamble(SBFD→TDD)}. The third power offset may be used when PRACH transmission occurs in SBFD symbols, and Message 3 PUSCH transmission occurs in non-SBFD symbols. The UE 115-a may be configured with a fourth power offset, msg3_{DeltaPreamble(SBFD→SBFD)}. The fourth power offset may be used when PRACH transmission occurs in SBFD symbols, and Message 3 PUSCH transmission occurs in SBFD symbols. If the UE 115-a is not configured with the fourth power offset, the UE 115-a may use the first power offset when PRACH transmission occurs in SBFD symbols, and Message 3 PUSCH transmission occurs in SBFD symbols.

In some examples, the UE 115-a may transmit capability information to the network entity 105-a. For example, the UE 115-a may transmit a capability report indicating capabilities of the UE 115-a associated with open loop power control of Message 3. In some examples, the UE 115-a may indicate multiple values of a supported power offset, or msg3_{DeltaPreamble}. In some examples, the supported power offset values may be correspond to different combinations of slot types for PRACH transmission and Message 3 transmission. For example, the UE 115-a may indicate a supported TDD power offset parameter (e.g., msg3_{DeltaPreamble(TDD)}), a supported SBFD power offset parameter (e.g., msg3_{DeltaPreamble(SBFD)}), a supported power offset for switching from TDD to SBFD for PRACH to PUSCH (e.g., msg3_{DeltaPreamble(TDD→SBFD)}), a supported power offset for switching from SBFD to TDD for PRACH transmission to PUSCH transmission (e.g., msg3_{DeltaPreamble(SBFD→TDD)}), or a supported power offset for using SBFD resources for both PRACH transmission and PUSCH transmission in a random access procedure (e.g., msg3_{DeltaPreamble(SBFD→SBFD)}), or any combination thereof.

The open loop power control techniques described herein may be implemented for single shot Message 3 PUSCH transmission or Message A PUSCH transmission. These techniques may be implemented for retransmission for fallback from Type-2 random access procedures to Type-4 random access procedures. These techniques may be implemented for multiple-slot Message 3 PUSCH transmission (e.g., Message 3 repetition) in SBFD symbols or non-SBFD symbols. These techniques may be implemented for multiple-slot Message A PUSCH transmission in SBFD symbols or non-SBFD symbols. These techniques may be applied for both contention-based random access procedures and contention-free random access procedures. These techniques may be applicable for Message 3 of a four-step random access procedure, or a Type-1 random access procedure, and for Message A of a two-step random access procedure, or a Type-2 random access procedure.

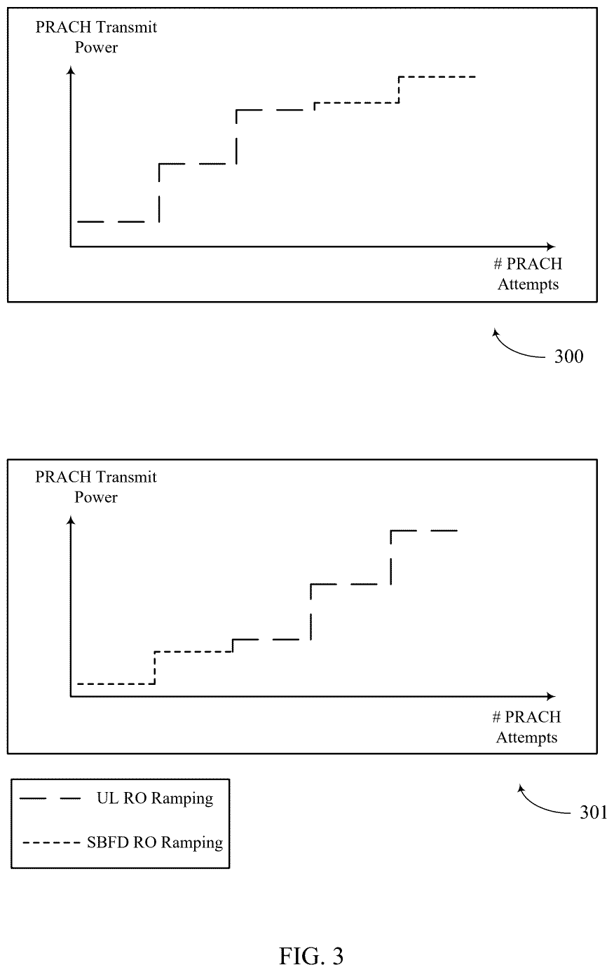

FIG. 3 shows an example of a power ramping scenario 300 and a power ramping scenario 301 that supports open loop power control of random access signaling in sub-band full duplex systems in accordance with one or more aspects of the present disclosure. The power ramping scenarios 300 and 301 may implement aspects of a wireless communications system 100 and a wireless communications system 200.

For example, a UE 115 may transmit a random access preamble for a random access procedure. The UE 115 may adjust a transmit power of the random access preamble according to a power ramping parameter for retransmissions of the random access preamble. In some examples, the UE 115 may transmit retransmissions of the random access preamble across different types of random access occasions.

For example, in the power ramping scenario 300, the UE 115 may perform an initial random access preamble transmission of a random access procedure in a TDD random access occasion, then the UE 115 may switch to transmitting retransmissions of the random access preamble in SBFD random access occasions. According to techniques described herein, the UE 115 may be scheduled to transmit an uplink shared channel message of the random access procedure in SBFD symbols or non-SBFD symbols in the power ramping scenario 300.

In the power ramping scenario 301, the UE 115 may perform an initial random access preamble transmission of a random access procedure in an SBFD random access occasion, then the UE 115 may switch to transmitting retransmissions of the random access preamble in TDD random access occasions. According to techniques described herein, the UE 115 may be scheduled to transmit an uplink shared channel message of the random access procedure in SBFD symbols or non-SBFD symbols in the power ramping scenario 301.

In some examples, the UE 115 may perform open loop power control for the uplink shared channel message of the random access procedure based on a type of random access occasion used to transmit the random access procedure. In the example of the power ramping scenario 300 and the power ramping scenario 301, the UE 115 may have transmitted, or retransmitted, the random access preamble in multiple types of random access occasions.

In some examples, the UE 115 may select a value for a target power parameter (e.g., Po₀) based on a random access occasion type of the initial PRACH transmission or based on a random access occasion type of a last PRACH transmission. Additionally, or alternatively, the UE 115 may select a value for a power offset parameter (e.g., msg3_{DeltaPreamble}) based on the random access occasion type of the initial PRACH transmission or the last PRACH transmission.

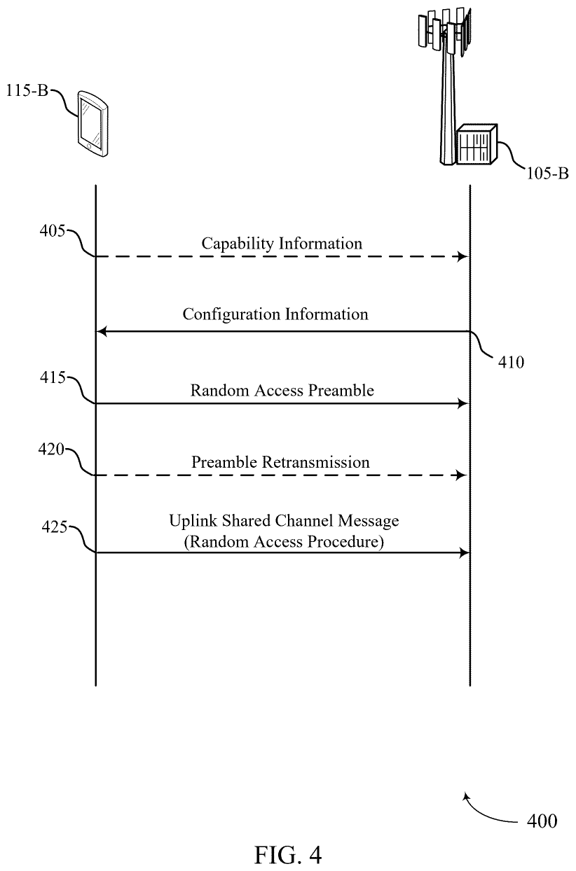

FIG. 4 shows an example of a process flow 400 that supports open loop power control of random access signaling in sub-band full duplex systems in accordance with one or more aspects of the present disclosure. The process flow 400 may implement aspects of a wireless communications system 100, a wireless communications system 200, as described with reference to FIGS. 1 and 2. For example, the process flow 400 may be implemented by a UE 115-b or a network entity 105-b, or both, which may be respective examples of a UE 115 and a network entity 105 described herein.

In some examples, at 405, the UE 115-b may transmit capability information to the network entity 105-b. For example, the UE 115-b may transmit capability information that indicates multiple values for multiple power offset parameters. For example, the UE 115-b may indicate multiple msg3_{DeltaPreamble} values. In some examples, the UE 115-b may indicate power offset parameters associated with different types of slots or associated with switching between different types of slots for PRACH transmission and PUSCH transmission.

At 410, the network entity 105- b may transmit configuration information to the UE 115-b. For example, the UE 115-b may receive random access configuration information that indicates a set of target power parameters and a set of power offset parameters. The set of target power parameters may include, for example, different values for P₀, such as a target power associated with TDD slots (e.g., P_{0(TDD)}), a target power associated with SBFD slots (e.g., P_{0(SBFD)}), or one or more target power parameters associated with specific scenarios described herein. The set of power offset parameters may include, for example, different values for msg3_{DeltaPreamble}, such as a power offset associated with TDD slots (e.g., msg3_{DeltaPreamble(TDD)}), a power offset associated with SBFD slots (e.g., msg3_{DeltaPreamble(SBFD)}) or one or more power offset parameters associated with specific scenarios described herein. For example, the configuration information may indicate different power offset parameters different slot types or different combinations of slot types that are used for PRACH transmission and PUSCH transmission. In some examples, the set of target power parameters may be associated with one of a first slot type or a second slot type. In some examples, the set of power offset parameters may be associated with one of the first slot type or the second slot type.

At 415, the UE 115-b may transmit a random access preamble of a random access procedure to the network entity 105-b. For example, the UE 115-b may transmit a random access message during a random access occasion of the first slot type according to a first target power parameter of the set of target power parameters and a power ramping parameter. In some examples, the UE 115-b may retransmit the random access preamble one or more times at 420. The UE 115-b may perform power control for PRACH retransmission according to the power step parameter. In some examples, the UE 115-b may perform PRACH retransmission using a first type of random access occasion (e.g., a TDD random access occasion) or a second type of random access occasion (e.g., an SBFD random access occasion), or both. The power ramping scenarios 300 as described with reference to FIG. 3 show examples of switching types of random access occasions during PRACH retransmission.

At 425, the UE 115-b may transmit an uplink shared channel message of the random access procedure to the network entity 105-b. In some examples, the UE 115-b may transmit the uplink shared channel message using the uplink shared channel resource according to the second target power parameter that is associated with the second slot type and the power offset parameter that is associated with the first slot type. For example, the UE 115-b may set a nominative transmit power for the uplink shared channel message based on a target power parameter that is associated with the first slot type (e.g., P_{0(TDD)}), and based on a power offset parameter that is associated with the second slot type (e.g., msg3_{DeltaPreamble(SBFD)}). In some examples, the UE 115-b may transmit the uplink shared channel message using the uplink shared channel resource according to the second target power parameter that is associated with the first slot type and the power offset parameter that is associated with the second slot type. For example, the UE 115-b may set a nominative transmit power for the uplink shared channel message based on a target power parameter that is associated with the first slot type (e.g., P_{0(SBFD)}), and based on a power offset parameter that is associated with the second slot type (e.g., msg3_{DeltaPreamble(TDD)}).

In some other examples, the UE 115-b may transmit the uplink shared channel message according to a target power parameter or a power offset parameter that is configured to be used when the UE 115-b transmits the random access preamble on the first slot type and the uplink shared channel message on the second slot type. For example, the UE 115-b may be configured with a power offset parameter associated with switching from a TDD random access occasion to SBFD symbols for the uplink shared channel message (e.g., msg3_{DeltaPreamble(TDD→SBFD)}), a power offset parameter associated with switching from an SBFD random access occasion to TDD symbols for the uplink shared channel message (e.g., msg3_{DeltaPreamble(SBFD→TDD)}), or a power offset parameter associated with performing PRACH transmission on an SBFD random access occasion and PUSCH transmission in SBFD resources (e.g., msg3_{DeltaPreamble(SBFD→SBFD)}).

In some examples, the UE 115-b may determine a value for the power offset parameter. For example, the UE 115-b may determine the power offset parameter based on a first power offset parameter associated with the first slot type (e.g., msg3_{DeltaPreamble(TDD)} and a difference between the first target power parameter associated with the first slot type (e.g., P_{0(TDD)}) and the second target power parameter that is associated with the second slot type (e.g., P_{0(SBFD)}.

In some examples, such as if the UE 115-b performs PRACH retransmission across random access occasions of different types, the UE 115-b may select between multiple target power parameters. For example, the UE 115-b may select a target power parameter based on a slot type associated with a first random access occasion of an initial PRACH transmission, or the UE 115-b may select the target power parameter based on a slot type associated with a last random access occasion of the PRACH retransmissions. The UE 115-b may additionally, or alternatively, select the power offset parameter based on the slot type associated with the first random access occasion of the initial PRACH transmission or the slot type associated with the last random access occasion of the PRACH retransmissions.

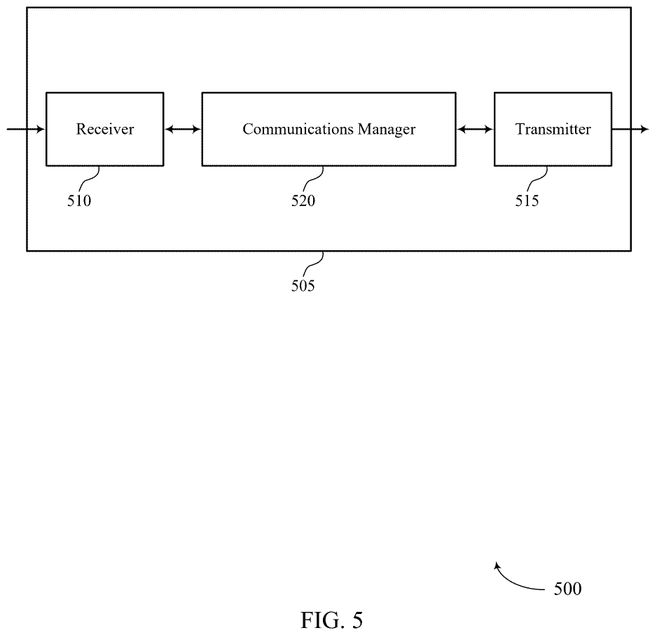

FIG. 5 shows a block diagram 500 of a device 505 that supports open loop power control of random access signaling in sub-band full duplex systems in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to open loop power control of random access signaling in sub-band full duplex systems). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to open loop power control of random access signaling in sub-band full duplex systems). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of open loop power control of random access signaling in sub-band full duplex systems as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving random access configuration information that indicates a set of multiple target power parameters and a set of multiple power offset parameters, where the set of multiple target power parameters are associated with one of a first slot type or a second slot type and the set of multiple power offset parameters are associated with one of the first slot type or the second slot type. The communications manager 520 is capable of, configured to, or operable to support a means for transmitting a random access message during a random access occasion of the first slot type according to a first target power parameter of the set of multiple target power parameters and a power ramping parameter. The communications manager 520 is capable of, configured to, or operable to support a means for transmitting an uplink shared channel message using an uplink shared channel resource of the second slot type according to a second target power parameter of the set of multiple target power parameters and a power offset parameter of the set of multiple power offset parameters.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

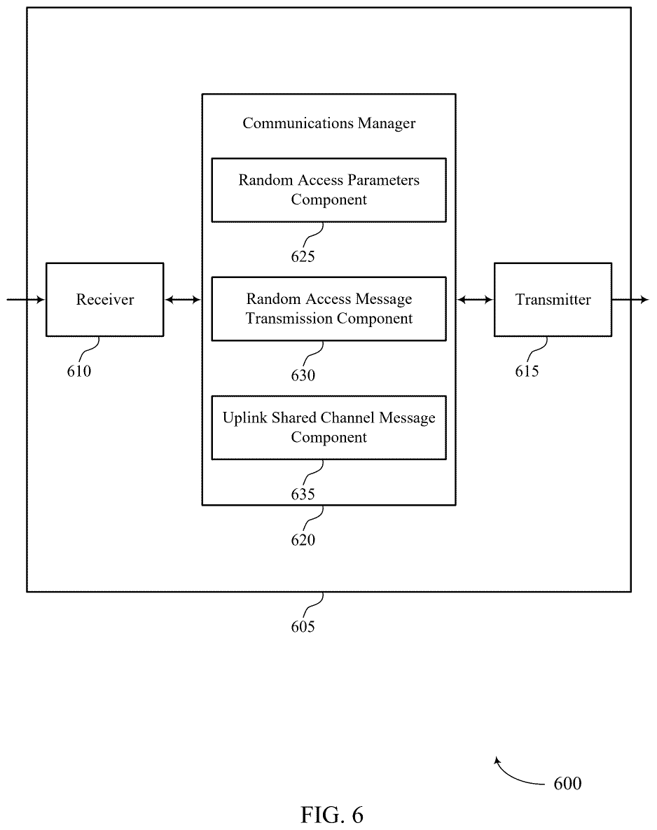

FIG. 6 shows a block diagram 600 of a device 605 that supports open loop power control of random access signaling in sub-band full duplex systems in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to open loop power control of random access signaling in sub-band full duplex systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to open loop power control of random access signaling in sub-band full duplex systems). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of open loop power control of random access signaling in sub-band full duplex systems as described herein. For example, the communications manager 620 may include a random access parameters component 625, a random access message transmission component 630, an uplink shared channel message component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The random access parameters component 625 is capable of, configured to, or operable to support a means for receiving random access configuration information that indicates a set of multiple target power parameters and a set of multiple power offset parameters, where the set of multiple target power parameters are associated with one of a first slot type or a second slot type and the set of multiple power offset parameters are associated with one of the first slot type or the second slot type. The random access message transmission component 630 is capable of, configured to, or operable to support a means for transmitting a random access message during a random access occasion of the first slot type according to a first target power parameter of the set of multiple target power parameters and a first power offset parameter of the set of multiple power offset parameters. The uplink shared channel message component 635 is capable of, configured to, or operable to support a means for transmitting an uplink shared channel message using an uplink shared channel resource of the second slot type according to a second target power parameter of the set of multiple target power parameters and a second power offset parameter of the set of multiple power offset parameters.

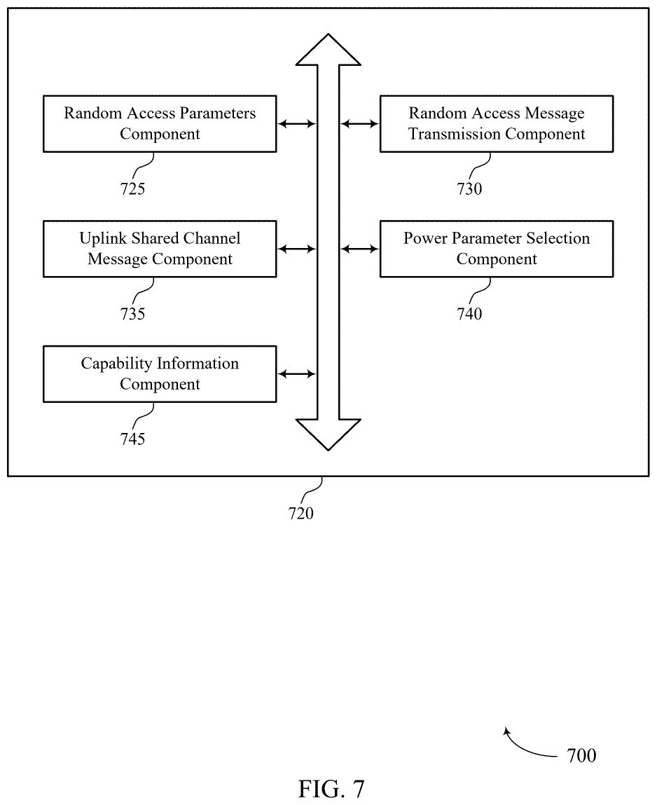

FIG. 7 shows a block diagram 700 of a communications manager 720 that supports open loop power control of random access signaling in sub-band full duplex systems in accordance with one or more aspects of the present disclosure. The communications manager 720 may be an example of aspects of a communications manager 520, a communications manager 620, or both, as described herein. The communications manager 720, or various components thereof, may be an example of means for performing various aspects of open loop power control of random access signaling in sub-band full duplex systems as described herein. For example, the communications manager 720 may include a random access parameters component 725, a random access message transmission component 730, an uplink shared channel message component 735, a power parameter selection component 740, a capability information component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The random access parameters component 725 is capable of, configured to, or operable to support a means for receiving random access configuration information that indicates a set of multiple target power parameters and a set of multiple power offset parameters, where the set of multiple target power parameters are associated with one of a first slot type or a second slot type and the set of multiple power offset parameters are associated with one of the first slot type or the second slot type. The random access message transmission component 730 is capable of, configured to, or operable to support a means for transmitting a random access message during a random access occasion of the first slot type according to a first target power parameter of the set of multiple target power parameters and a first power offset parameter of the set of multiple power offset parameters. The uplink shared channel message component 735 is capable of, configured to, or operable to support a means for transmitting an uplink shared channel message using an uplink shared channel resource of the second slot type according to a second target power parameter of the set of multiple target power parameters and a power offset parameter of the set of multiple power offset parameters.

In some examples, to support transmitting the uplink shared channel message, the uplink shared channel message component 735 is capable of, configured to, or operable to support a means for transmitting the uplink shared channel message using the uplink shared channel resource according to the second target power parameter that is associated with the second slot type and the power offset parameter that is associated with the first slot type.

In some examples, to support transmitting the uplink shared channel message, the uplink shared channel message component 735 is capable of, configured to, or operable to support a means for transmitting the uplink shared channel message using the uplink shared channel resource according to the second target power parameter that is associated with the first slot type and the power offset parameter that is associated with the second slot type.

In some examples, to support transmitting the uplink shared channel message, the uplink shared channel message component 735 is capable of, configured to, or operable to support a means for transmitting the uplink shared channel message using the uplink shared channel resource according to the second target power parameter that is associated with the second slot type and the power offset parameter that is associated with the second slot type, where the first slot type and the second slot type are the same.

In some examples, to support transmitting the random access message, the random access message transmission component 730 is capable of, configured to, or operable to support a means for transmitting a set of multiple random access messages during a respective set of multiple random access occasions, the set of multiple random access messages including the random access message and the respective set of multiple random access occasions including the random access occasion, where at least one of the second target power parameter or the power offset parameter is based on a slot type associated with a first random access occasion of the respective set of multiple random access occasions or a last random access occasion of the respective set of multiple random access occasions.

In some examples, the power parameter selection component 740 is capable of, configured to, or operable to support a means for selecting at least one of the second target power parameter from the set of multiple target power parameters and the power offset parameter from the set of multiple power offset parameters based on the uplink shared channel resource being of the second slot type.

In some examples, the power parameter selection component 740 is capable of, configured to, or operable to support a means for selecting at least one of the second target power parameter from the set of multiple target power parameters and the power offset parameter from the set of multiple power offset parameters based on a reference signal received power measurement or a path loss value satisfying a threshold.

In some examples, the random access parameters component 725 is capable of, configured to, or operable to support a means for determining the power offset parameter based on a first power offset parameter that is associated with the first slot type and a difference between the first target power parameter that is associated with the first slot type and the second target power parameter that is associated with the second slot type.

In some examples, switching from transmission of the random access message using time division duplex resources to transmission of the uplink shared channel message using sub-band full duplex resources. In some examples, switching from transmission of the random access message using the sub-band full duplex resources to transmission of the uplink shared channel message using the time division duplex resources. In some examples, transmission of both the random access message and the uplink shared channel message using the sub-band full duplex resources.

In some examples, the capability information component 745 is capable of, configured to, or operable to support a means for transmitting capability information that indicates a set of multiple values for the set of multiple power offset parameters including at least a first power offset associated with the first slot type and a second power offset associated with the second slot type.

In some examples, the first slot type is a sub-band full duplex slot and the second slot type is a time division duplex slot, or the first slot type is a time division duplex slot and the second slot type is a sub-band full duplex slot.

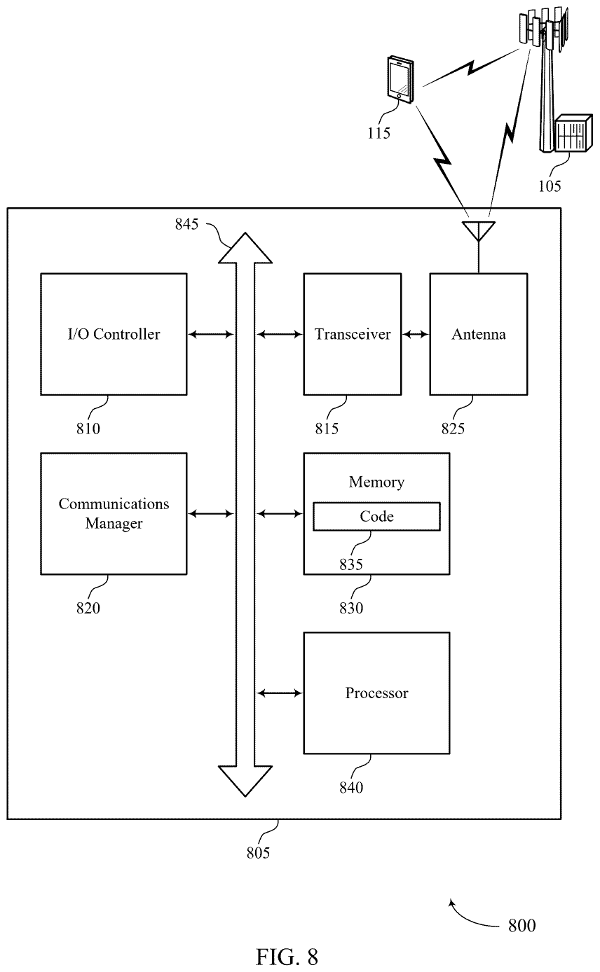

FIG. 8 shows a diagram of a system 800 including a device 805 that supports open loop power control of random access signaling in sub-band full duplex systems in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting open loop power control of random access signaling in sub-band full duplex systems). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving random access configuration information that indicates a set of multiple target power parameters and a set of multiple power offset parameters, where the set of multiple target power parameters are associated with one of a first slot type or a second slot type and the set of multiple power offset parameters are associated with one of the first slot type or the second slot type. The communications manager 820 is capable of, configured to, or operable to support a means for transmitting a random access message during a random access occasion of the first slot type according to a first target power parameter of the set of multiple target power parameters and a power ramping parameter. The communications manager 820 is capable of, configured to, or operable to support a means for transmitting an uplink shared channel message using an uplink shared channel resource of the second slot type according to a second target power parameter of the set of multiple target power parameters and a power offset parameter of the set of multiple power offset parameters.

By including or configuring the communications manager 820 in accordance with examples as described herein, the device 805 may support techniques for improved communication reliability, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of open loop power control of random access signaling in sub-band full duplex systems as described herein, or the at least one processor 840 and the at least one memory 830 may be otherwise configured to, individually or collectively, perform or support such operations.

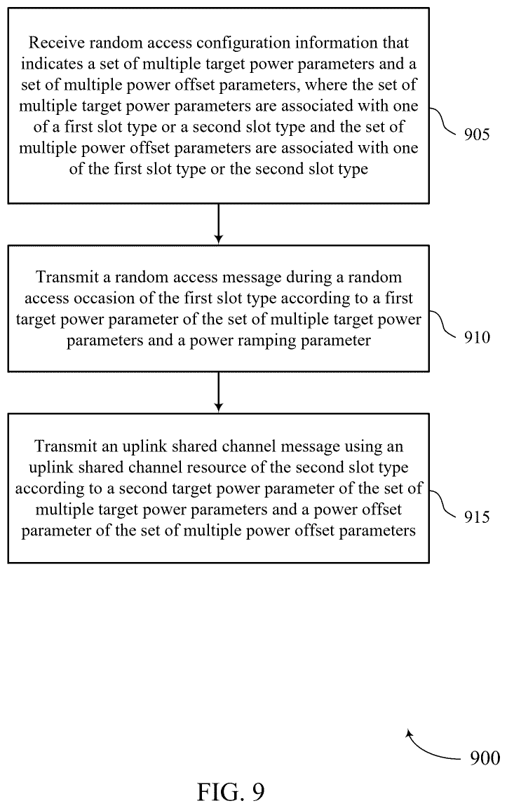

FIG. 9 shows a flowchart illustrating a method 900 that supports open loop power control of random access signaling in sub-band full duplex systems in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving random access configuration information that indicates a set of multiple target power parameters and a set of multiple power offset parameters, where the set of multiple target power parameters are associated with one of a first slot type or a second slot type and the set of multiple power offset parameters are associated with one of the first slot type or the second slot type. The operations of 905 may be performed in accordance with examples as disclosed herein. In some examples, aspects of the operations of 905 may be performed by a random access parameters component 725 as described with reference to FIG. 7.

At 910, the method may include transmitting a random access message during a random access occasion of the first slot type according to a first target power parameter of the set of multiple target power parameters and a power ramping parameter. The operations of 910 may be performed in accordance with examples as disclosed herein. In some examples, aspects of the operations of 910 may be performed by a random access message transmission component 730 as described with reference to FIG. 7.

At 915, the method may include transmitting an uplink shared channel message using an uplink shared channel resource of the second slot type according to a second target power parameter of the set of multiple target power parameters and a power offset parameter of the set of multiple power offset parameters. The operations of 915 may be performed in accordance with examples as disclosed herein. In some examples, aspects of the operations of 915 may be performed by an uplink shared channel message component 735 as described with reference to FIG. 7.

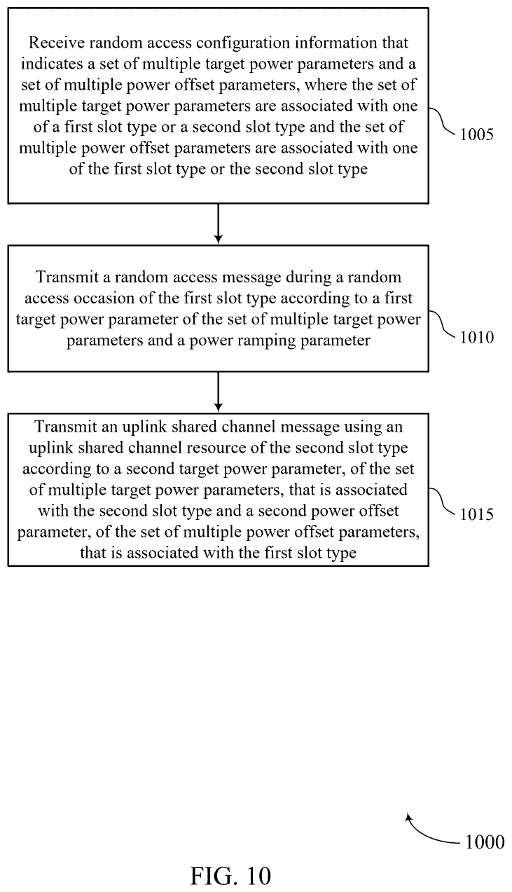

FIG. 10 shows a flowchart illustrating a method 1000 that supports open loop power control of random access signaling in sub-band full duplex systems in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving random access configuration information that indicates a set of multiple target power parameters and a set of multiple power offset parameters, where the set of multiple target power parameters are associated with one of a first slot type or a second slot type and the set of multiple power offset parameters are associated with one of the first slot type or the second slot type. The operations of 1005 may be performed in accordance with examples as disclosed herein. In some examples, aspects of the operations of 1005 may be performed by a random access parameters component 725 as described with reference to FIG. 7.

At 1010, the method may include transmitting a random access message during a random access occasion of the first slot type according to a first target power parameter of the set of multiple target power parameters and a power ramping parameter. The operations of 1010 may be performed in accordance with examples as disclosed herein. In some examples, aspects of the operations of 1010 may be performed by a random access message transmission component 730 as described with reference to FIG. 7.

At 1015, the method may include transmitting an uplink shared channel message using an uplink shared channel resource of the second slot type according to a second target power parameter, of the set of multiple target power parameters, that is associated with the second slot type and a second power offset parameter, of the set of multiple power offset parameters, that is associated with the first slot type. The operations of 1015 may be performed in accordance with examples as disclosed herein. In some examples, aspects of the operations of 1015 may be performed by an uplink shared channel message component 735 as described with reference to FIG. 7.

The following provides an overview of aspects of the present disclosure:

Aspect 1: A method for wireless communications at a UE, comprising: receiving random access configuration information that indicates a plurality of target power parameters and a plurality of power offset parameters, wherein the plurality of target power parameters are associated with one of a first slot type or a second slot type and the plurality of power offset parameters are associated with one of the first slot type or the second slot type; transmitting a random access message during a random access occasion of the first slot type according to a first target power parameter of the plurality of target power parameters and a power ramping parameter; and transmitting an uplink shared channel message using an uplink shared channel resource of the second slot type according to a second target power parameter of the plurality of target power parameters and a power offset parameter of the plurality of power offset parameters.

Aspect 2: The method of aspect 1, wherein transmitting the uplink shared channel message comprises: transmitting the uplink shared channel message using the uplink shared channel resource according to the second target power parameter that is associated with the second slot type and the power offset parameter that is associated with the first slot type.

Aspect 3: The method of any of aspects 1 through 2, wherein transmitting the uplink shared channel message comprises: transmitting the uplink shared channel message using the uplink shared channel resource according to the second target power parameter that is associated with the first slot type and the power offset parameter that is associated with the second slot type.

Aspect 4: The method of any of aspects 1 through 3, wherein transmitting the uplink shared channel message comprises: transmitting the uplink shared channel message using the uplink shared channel resource according to the second target power parameter that is associated with the second slot type and the power offset parameter that is associated with the second slot type, wherein the first slot type and the second slot type are a same slot type.

Aspect 5: The method of any of aspects 1 through 4, wherein transmitting the random access message comprises: transmitting a plurality of random access messages during a respective plurality of random access occasions based at least in part on the power ramping parameter, the plurality of random access messages comprising the random access message and the respective plurality of random access occasions comprising the random access occasion, wherein at least one of the second target power parameter or the power offset parameter is based at least in part on a slot type associated with a first random access occasion of the respective plurality of random access occasions or a last random access occasion of the respective plurality of random access occasions.

Aspect 6: The method of any of aspects 1 through 5, further comprising: selecting at least one of the second target power parameter from the plurality of target power parameters and the power offset parameter from the plurality of power offset parameters based at least in part on the uplink shared channel resource being of the second slot type.

Aspect 7: The method of any of aspects 1 through 6, further comprising: selecting at least one of the second target power parameter from the plurality of target power parameters and the power offset parameter from the plurality of power offset parameters based at least in part on a reference signal received power measurement or a path loss value satisfying a threshold.

Aspect 8: The method of any of aspects 1 through 7, further comprising: determining the power offset parameter based at least in part on a first power offset parameter that is associated with the first slot type and a difference between the first target power parameter that is associated with the first slot type and the second target power parameter that is associated with the second slot type.

Aspect 9: The method of any of aspects 1 through 8, wherein the power offset parameter is associated with switching from transmission of the random access message using time division duplex resources to transmission of the uplink shared channel message using sub-band full duplex resources; switching from transmission of the random access message using the sub-band full duplex resources to transmission of the uplink shared channel message using the time division duplex resources; or transmission of both the random access message and the uplink shared channel message using the sub-band full duplex resources.

Aspect 10: The method of any of aspects 1 through 9, further comprising: transmitting capability information that indicates a plurality of values for the plurality of power offset parameters comprising at least a first power offset associated with the first slot type and a second power offset associated with the second slot type.

Aspect 11: The method of any of aspects 1 through 10, wherein the first slot type is a sub-band full duplex slot and the second slot type is a time division duplex slot, or the first slot type is a time division duplex slot and the second slot type is a sub-band full duplex slot.

Aspect 12: A UE for wireless communications, comprising one or more memories storing processor-executable code, and one or more processors coupled with the one or more memories and individually or collectively operable to execute the code to cause the UE to perform a method of any of aspects 1 through 11.

Aspect 13: A UE for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive random access configuration information that indicates a plurality of target power parameters and a plurality of power offset parameters, wherein the plurality of target power parameters are associated with one of a first slot type or a second slot type and the plurality of power offset parameters are associated with one of the first slot type or the second slot type;
transmit a random access message during a random access occasion of the first slot type according to a first target power parameter of the plurality of target power parameters and a power ramping parameter; and
transmit an uplink shared channel message using an uplink shared channel resource of the second slot type according to a second target power parameter of the plurality of target power parameters and a power offset parameter of the plurality of power offset parameters.

2. The UE of claim 1, wherein, to transmit the uplink shared channel message, the one or more processors are individually or collectively operable to execute the code to cause the UE to:
transmit the uplink shared channel message using the uplink shared channel resource according to the second target power parameter that is associated with the second slot type and the power offset parameter that is associated with the first slot type.

3. The UE of claim 1, wherein, to transmit the uplink shared channel message, the one or more processors are individually or collectively operable to execute the code to cause the UE to:
transmit the uplink shared channel message using the uplink shared channel resource according to the second target power parameter that is associated with the first slot type and the power offset parameter that is associated with the second slot type.

4. The UE of claim 1, wherein, to transmit the uplink shared channel message, the one or more processors are individually or collectively operable to execute the code to cause the UE to:
transmit the uplink shared channel message using the uplink shared channel resource according to the second target power parameter that is associated with the second slot type and the power offset parameter that is associated with the second slot type, wherein the first slot type and the second slot type are a same slot type.

5. The UE of claim 1, wherein, to transmit the random access message, the one or more processors are individually or collectively operable to execute the code to cause the UE to:
transmit a plurality of random access messages during a respective plurality of random access occasions based at least in part on the power ramping parameter, the plurality of random access messages comprising the random access message and the respective plurality of random access occasions comprising the random access occasion, wherein at least one of the second target power parameter or the power offset parameter is based at least in part on a slot type associated with a first random access occasion of the respective plurality of random access occasions or a last random access occasion of the respective plurality of random access occasions.

6. The UE of claim 1, wherein the one or more processors are individually or collectively further operable to execute the code to cause the UE to:
select at least one of the second target power parameter from the plurality of target power parameters and the power offset parameter from the plurality of power offset parameters based at least in part on the uplink shared channel resource being of the second slot type.

7. The UE of claim 1, wherein the one or more processors are individually or collectively further operable to execute the code to cause the UE to:
select at least one of the second target power parameter from the plurality of target power parameters and the power offset parameter from the plurality of power offset parameters based at least in part on a reference signal received power measurement or a path loss value satisfying a threshold.

8. The UE of claim 1, wherein the one or more processors are individually or collectively further operable to execute the code to cause the UE to:
determine the power offset parameter based at least in part on a first power offset parameter that is associated with the first slot type and a difference between the first target power parameter that is associated with the first slot type and the second target power parameter that is associated with the second slot type.

9. The UE of claim 1, wherein the power offset parameter is associated with:
switching from transmission of the random access message using time division duplex resources to transmission of the uplink shared channel message using sub-band full duplex resources;
switching from transmission of the random access message using the sub-band full duplex resources to transmission of the uplink shared channel message using the time division duplex resources; or
transmission of both the random access message and the uplink shared channel message using the sub-band full duplex resources.

10. The UE of claim 1, wherein the one or more processors are individually or collectively further operable to execute the code to cause the UE to:
transmit capability information that indicates a plurality of values for the plurality of power offset parameters comprising at least a first power offset associated with the first slot type and a second power offset associated with the second slot type.

11. The UE of claim 1, wherein the first slot type is a sub-band full duplex slot and the second slot type is a time division duplex slot, or the first slot type is a time division duplex slot and the second slot type is a sub-band full duplex slot.

12. A method for wireless communications at a user equipment (UE), comprising:
receiving random access configuration information that indicates a plurality of target power parameters and a plurality of power offset parameters, wherein the plurality of target power parameters are associated with one of a first slot type or a second slot type and the plurality of power offset parameters are associated with one of the first slot type or the second slot type;
transmitting a random access message during a random access occasion of the first slot type according to a first target power parameter of the plurality of target power parameters and a power ramping parameter; and
transmitting an uplink shared channel message using an uplink shared channel resource of the second slot type according to a second target power parameter of the plurality of target power parameters and a power offset parameter of the plurality of power offset parameters.

13. The method of claim 12, wherein transmitting the uplink shared channel message comprises:
transmitting the uplink shared channel message using the uplink shared channel resource according to the second target power parameter that is associated with the second slot type and the power offset parameter that is associated with the first slot type.

14. The method of claim 12, wherein transmitting the uplink shared channel message comprises:
transmitting the uplink shared channel message using the uplink shared channel resource according to the second target power parameter that is associated with the first slot type and the power offset parameter that is associated with the second slot type.

15. The method of claim 12, wherein transmitting the uplink shared channel message comprises:
transmitting the uplink shared channel message using the uplink shared channel resource according to the second target power parameter that is associated with the second slot type and the power offset parameter that is associated with the second slot type, wherein the first slot type and the second slot type are a same slot type.

16. The method of claim 12, wherein transmitting the random access message comprises:
transmitting a plurality of random access messages during a respective plurality of random access occasions based at least in part on the power ramping parameter, the plurality of random access messages comprising the random access message and the respective plurality of random access occasions comprising the random access occasion, wherein at least one of the second target power parameter or the power offset parameter is based at least in part on a slot type associated with a first random access occasion of the respective plurality of random access occasions or a last random access occasion of the respective plurality of random access occasions.

17. The method of claim 12, further comprising:
selecting at least one of the second target power parameter from the plurality of target power parameters and the power offset parameter from the plurality of power offset parameters based at least in part on the uplink shared channel resource being of the second slot type.

18. The method of claim 12, further comprising:
selecting at least one of the second target power parameter from the plurality of target power parameters and the power offset parameter from the plurality of power offset parameters based at least in part on a reference signal received power measurement or a path loss value satisfying a threshold.

19. The method of claim 12, further comprising:
determining the power offset parameter based at least in part on a first power offset parameter that is associated with the first slot type and a difference between the first target power parameter that is associated with the first slot type and the second target power parameter that is associated with the second slot type.

20. A non-transitory computer-readable medium storing code for wireless communications, the code comprising instructions executable by one or more processors to:
receive random access configuration information that indicates a plurality of target power parameters and a plurality of power offset parameters, wherein the plurality of target power parameters are associated with one of a first slot type or a second slot type and the plurality of power offset parameters are associated with one of the first slot type or the second slot type;
transmit a random access message during a random access occasion of the first slot type according to a first target power parameter of the plurality of target power parameters and a power ramping parameter; and
transmit an uplink shared channel message using an uplink shared channel resource of the second slot type according to a second target power parameter of the plurality of target power parameters and a power offset parameter of the plurality of power offset parameters.
